(19) United States
(12) Patent Application Publication
(10) Pub. No.: US 2025/0383864 A1
(43) Pub. Date: Dec. 18, 2025

(54) Bi-directional Synchronization of Authoring and Simulation Environments

(71) Applicant: Niantic Spatial, Inc., San Francisco, CA (US)

(72) Inventors: Christoph Michael Bartschat, Mountain View, CA (US); Rigel Gareth Benton, Mountain View, CA (US); Dale Ross, San Francisco, CA (US); Jonathan Tran, Mountain View, CA (US); Julie Soohoo, San Francisco, CA (US); Alan Castillo, San Francisco, CA (US); Hsin Yu Hu, San Francisco, CA (US); Amanda Whitt, San Francisco, CA (US); Dat Tan Chu, San Jose, CA (US); Nicholas John Butko, Cupertino, CA (US); Erik Marshall Murphy-Chutorian, Palo Alto, CA (US)

(21) Appl. No.: 19/242,685

(22) Filed: Jun. 18, 2025

Related U.S. Application Data
(60) Provisional application No. 63/661,542, filed on Jun. 18, 2024.

(51) Int. Cl. G06F 8/65

(52) U.S. Cl. CPC G06F 8/65

(57) ABSTRACT

A development system provides an editor and a simulator between which changes are bi-directionally synchronized. As the simulator runs the application logic, objects may be spawned and destroyed. Object properties (e.g., colors, positions, behaviors, etc.) can also change as time passes. The developer can see these changes in the editor view in real time. The developer can make changes in the editor view that persist and are synchronized in real time to the simulator.

### CROSS-REFERENCE TO RELATED APPLICATIONS

This application claims the benefit of U.S. Provisional Application No. 63/661,542, filed Jun. 18, 2024, which is incorporated by reference.

### TECHNICAL FIELD

The subject matter described relates generally to creating virtual content and, in particular, to synchronizing an editor and simulation of the end user experience such that changes to a virtual environment in either propagate automatically to the other.

### BACKGROUND

In conventional application development environments, a developer authors changes and then needs to spend a significant amount of time compiling their code to see their changes take effect. Some tools exist that provide an emulation environment that can avoid the need to compile code changes, but this still requires switching between authoring an emulating to see and test changes, wasting valuable time. Furthermore, changes in the environment that occur due to the emulation process are not available in the authoring environment.

### SUMMARY

The above and other problems may be addressed by a development system that provides an editor and a simulator between which changes are bi-directionally synchronized. As the simulator runs the application logic, objects may be spawned and destroyed. Object properties (e.g., colors, positions, behaviors, etc.) can also change as time passes. The developer can see these changes in the editor view in real time. The developer can make changes in the editor view that persist and are synchronized in real time to the simulator. This allows developers to author and adjust their game logic in real time without expensive compilation steps.

### BRIEF DESCRIPTION OF THE DRAWINGS

FIG. 1 is a block diagram of a networked computing environment suitable for application development, according to one embodiment.

FIG. 2 is a block diagram of the development server of FIG. 1, according to one embodiment.

FIG. 3 is a flowchart of a method for providing two-way synchronization between an editor and a simulator, according to one embodiment.

FIG. 4 is a block diagram illustrating an example of a computer suitable for use in the networked computing environment of FIG. 1, according to one embodiment.

### DETAILED DESCRIPTION

The figures and the following description describe certain embodiments by way of illustration only. One skilled in the art will readily recognize from the following description that alternative embodiments of the structures and methods may be employed without departing from the principles described. Wherever practicable, similar or like reference numbers are used in the figures to indicate similar or like functionality. Where elements share a common numeral followed by a different letter, this indicates the elements are similar or identical. A reference to the numeral alone generally refers to any one or any combination of such elements, unless the context indicates otherwise.

### Overview

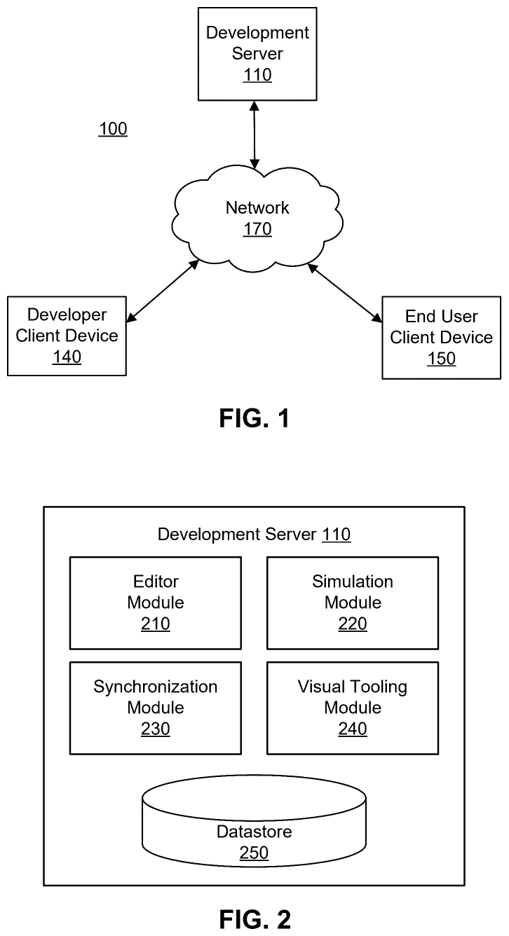

FIG. 1 illustrates one embodiment of a networked computing environment 100 suitable for application development with two-way synchronization between an editor and a simulator. In the embodiment shown, the networked computing environment 100 includes a development server 110, a developer client device 140, and an end user client device 150, all connected via a network 170. In other embodiments, the networked computing environment includes different or additional elements. In addition, the functions may be distributed among the elements in a different manner than described.

The development server 110 includes one or more computing devices that provide a suite of application development tools, also referred to as the studio, with which developers may create applications. The studio is described being used to create augmented reality applications (e.g., games) that overlay virtual content on images (e.g., a real time video) of the real world, but the disclosed techniques may be applied to development of other types of application. In one embodiment, the studio includes an editor and a simulator. The editor provides an interface with which a developer can create or modify a virtual environment, such as authoring virtual content and defining its behavior within the virtual environment. The simulator executes application logic, resulting in changes to the virtual environment. Any changes made to the virtual environment are bidirectionally synchronized, meaning that changes made in the editor are propagated to the simulator and vice versa. Various embodiments of the development server 110 are described in greater detail below, with reference to FIG. 2.

The developer client device 140 is a computing device with which a developer accesses the functionality provided by the development server 110. Although a single developer client device 140 is shown for convenience, the networked computing environment 100 can include any number of such devices. In one embodiment, a developer uses an internet browser on the developer client device 140 to access the studio provided by the development server 110. Thus, the developer may develop applications without the need for specialized software to be installed locally. In other embodiments, dedicated software may be installed on the developer client device 140 to access the studio functionality provider by the development server 110.

The end user client device 150 is a computing device with which an end user may use applications developed using the studio. In one embodiment, the end user client device 150 is a smart phone or other mobile device that runs an augmented reality application such as parallel reality game that was developed using the studio. Virtual content authored in the studio may be provided for display by the end user client device 150 overlaid onto images (e.g., a video feed) captured by one or more cameras of the end user client device 150.

The network 170 provides the communication channels via which the other elements of the networked computing environment 100 communicate. The network 170 can include any combination of local area and wide area networks, using wired or wireless communication systems. In one embodiment, the network 170 uses standard communications technologies and protocols. For example, the network 170 can include communication links using technologies such as Ethernet, 802.11, worldwide interoperability for microwave access (WiMAX), 3G, 4G, 5G, code division multiple access (CDMA), digital subscriber line (DSL), etc. Examples of networking protocols used for communicating via the network 170 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 170 may be represented using any suitable format, such as hypertext markup language (HTML) or extensible markup language (XML). In some embodiments, some or all of the communication links of the network 170 may be encrypted using any suitable technique or techniques.

### Example Development Server

FIG. 2 illustrates one embodiment of the development server 110. In the embodiment shown, the development server 110 includes an editor module 210, a simulation module 220, a synchronization module 230, a visual tooling module 240, and a datastore 250. In other embodiments, the development server 110 includes different or additional elements. In addition, the functions may be distributed among the elements in a different manner than described. For example, although the editor module 210 and simulator module 220 are shown as being part of the same server 110, the functionality of each may be provided by different computing devices that communicate via the network 170.

The editor module 210 provides an editor with which a developer may author content. In one embodiment, the content is virtual content for inclusion in an augmented reality application, such as a parallel-reality game. Using the editor, a developer may define virtual objects, set properties for those objects, and define behavior for those objects. For example, a virtual bird may be assigned a type (e.g., species), size, color, location, and flight path. The flight path may be a circle centered on another object or at a specified set of coordinates for which the developer can set a radius. It should be appreciated that a wide range of virtual content may be authored using the editor to meet the demands of whatever application a developer wishes to build.

In addition to defining initial set of properties of virtual objects, in one embodiment, the editor module 210 may allow developers to refine and modify properties during the development process. The developers can make adjustments to the properties based on real-time feedback from the simulation, such as altering the position, scale, behavior, or other properties of virtual objects, fine-tuning the associated virtual content to simulate as desired. For example, if a developer creates a virtual ball in the editor and detects during simulation that the ball's speed is too fast or slow, the developers can adjust the ball's physics properties (e.g., mass, velocity, etc.) in the editor. These changes are then immediately reflected in the simulator, allowing the developer to test the updated behavior in real-time. The simulation process will further be explained in simulation module 220.

In one embodiment, the editor module 210 enables both direct coding (e.g. using HTML, JavaScript, and frameworks like A-Frame or Three.js) and spatial editing via visual placement tools. This hybrid approach allows a developer to prototype efficiently and fast while maintaining the flexibility for advanced customization for complex logic implementation.

The editor module 210 may enable QR code generation for live testing on mobile devices, and offers live reloading to reflect changes during development. Additionally, the editor module 210 may incorporate built-in version control tools, such as staging changes, commit landing, and build publishing, supporting streamlined development pipeline. These features allow a developer to manage and track changes efficiently within the same environment, reducing the need for external tools.

In one embodiment, the editor module 210 may provide an interface for selecting a target device, which informs how simulations and previews are conducted. This allows a developer to tailor corresponding content creation to the characteristics of specific target device. Upon selection, the target device profile may be transmitted to the simulation module 220, allowing it to emulate the application's behavior and rendering characteristics accordingly.

The simulation module 220 provides a simulation that emulates behavior of the application on a target device. The target device may be a default device type or may be selected from a list of supported devices so that the application can be tested for different end user device types. In one embodiment, the simulator runs the application logic without any special modifications. The application logic may result in objects being created or destroyed, or the properties of objects changing. For example, a user may plant a tree, paint a wall, or pop a balloon, etc. It should be appreciated that a wide range of object creations, destructions, and modifications may be possible, depending on the specific logic and nature of the application.

The simulation module 220 may enable users to interact with virtual content as part of the application, allowing developers to test object behaviors, interactions and physics in real-world scenarios. For example, a developer may simulate a user kicking a virtual ball, observing how the ball reacts to the kicking force, trajectory, and environmental conditions such as rain or surface friction. The simulation module 220 may model how the ball's speed, direction, and spin change in response to the kick, allowing developers refine properties of the ball to capture realistic movements within the virtual environment.

In one embodiment, the simulation module 220 may invoke an external development tool (e.g. debugging tools) upon identifying a runtime exception, a developer defined flag during the execution of a virtual reality experience on a target device. This can enable timely inspection and analysis of the application logic state, variable values, and trace event flows.

The synchronization module 230 provides bi-directional synchronization between the editor and the simulator. When the developer makes changes to the virtual content in the editor, those changes are automatically propagated to the simulator without the need for recompilation of code. Similarly, any changes in the virtual content caused by the application logic in the simulator propagate back to the editor where they can be viewed by the developer. Such changes can be persistent in both the editor and the simulator.

In one embodiment, the synchronization module 230 uses a conflict-free replicated data type (CRDT) library for conflict free synchronization. Such libraries are typically built for synchronizing documents, which requires relatively small amounts of data to be transferred between systems. In the context of updating virtual content, the amount of data that defines the virtual content presents challenges for transferring between systems without unmanageable lag or data losses. To avoid the list of state changes growing indefinitely, the synchronization module 230 compacts the changes into one change per user's edit. This allows for user edits to be kept on an undo stack with the application state being the state at the top of the stack with the single compacted simulator change applied.

In some embodiments, changes are split into two types: those that are expected to occur frequently and those that are expected to be less frequent. To prevent the list of state changes becoming too large, changes of a type that are expected to occur frequently are synchronized directly between the editor and simulator without reference to the CRDT library while changes of a type that are expected to be less frequent are logged in the CRDT library. For example, object transformation updates (changes to the position, rotation, and scale of objects in 3D space) are expected to change frequently (e.g., 60+ times a second due to physics-based simulation changing these properties) and are synchronized without using CRDT. Other updates, such as the creation or destruction of new objects, occur less frequently and are updated using CRDT. Non-CRDT updates are propagated by sending messages periodically or when a certain number of updates have occurred from the simulator to the editor (and vice versa) with the updates on object transformations. On receiving an update message, the receiving entity (simulator or editor) determines whether it is a CRDT update or non-CRDT update and processes it accordingly.

Specifically, the synchronization module 230 may maintain two copies of the virtual content. The first remains unchanged from the most recently synchronized state while the other reflects all changes made by the developer or application logic. To synchronize the editor to the simulator (or vice versa), the synchronization module 230 compares the two versions to determine the impact of aggregating all of the changes made since the previous synchronization and sends a representation of the differences between them as a single update rather than sending every change made as an individual update. In some embodiments, the size of each update is balanced with the time between updates dynamically based on available bandwidth between the editor and simulator. The latency or available bandwidth can be measured using one or more metrics (e.g., by measuring packet loss or comparing timestamps) and the timing of updates adjusted accordingly. Generally, less frequent updates lead to larger updates, which can cause packet loss, but more frequent (smaller) updates require more resources to implement.

The synchronization module 230 may include a session component that manages the lifecycle and identity of users or devices participating in the simulation process. In one embodiment, session component tracks when the users join, leave, or reconnect, and allows the correct synchronized state upon entry or recovery. Session components provide a mechanism that enables scoped synchronization, allowing multiple independent experiences to run concurrently without conflict. Additionally, session metadata may be used to control access permissions, coordinate interactions, or audit session activity for diagnostic purposes.

The session metadata may be structured in a machine-readable format such as JSON, and may include fields like session identifiers, user roles, connection timestamps, and device identifiers. For example, as developers refine virtual content properties (e.g., position, scale, physics attributes) using the editor module 210 and observe real-time results in the simulation module 220, the session metadata may be used to maintain consistency of state across user sessions, track changes by specific users, and manage access to editing and testing functionality. An example session metadata structure is shown below:

```
{
  “sessionId: “abc123”,
  “userId”: “user123”,
  “role”: “editor”,
  “connectedAt: “2025-06-09T10:15:00Z”,
  “deviceId”: “device123”,
  “status”: “active”,
  “objectId”: “virtualBall001”,
  “previousAction”: {
    “type”: “modify”,
    “field”: “velocity”,
    “scale”: “0.2m/s”
  }
}
```

These metadata may be exchanged within the system to manage state consistency and user-specific logic throughout the simulation process.

The visual tooling module 240 provides pre-collected sensor data to the simulator to enable testing of applications as if an end user device 150 was capturing sensor data in real time as the application logic executes. Data from real sensors (e.g., one or more of an IMU, GPS, or camera, etc.) is captured in advance and stored. In various embodiments, video of a scene is captured by a camera and data from one or more other sensors (e.g., an IMU or GPS system) is captured, with the video and other sensor data stored with timestamps indicating timing alignment between the different sensor data sources. For example, a camera may capture a sequence of images where an actor's facial expression and motion are captured, with IMU data indicating motion of the camera relative to the actor, and the simulator can then move a virtual face representation using a face detection system that causes the virtual face's motion to match that of the actor's in the video.

In one such embodiment, the visual tooling module 240 accesses a stored video and associated additional sensor data (e.g., from the datastore) and converts it into a standard frame format that is provided to the simulation module 220. The standard frame format matches what an end user client device 150 would provide to the application at run time with regard to camera and other sensor data. Thus, from the perspective of the simulation module 220, it is receiving a data from a real device that is providing a real time camera feed of a scene. Thus, the developer can author an augmented reality experience on top of images of the scene (e.g., the moving face of the actor mentioned previously) without requiring a real device to capture video. It should be appreciated that a wide range of video and other sensor data depicting a wide range of scenes may be pre-captured and provided to the simulation module 220. For example, the developer may be able to select from a library of scenes to find one that is well suited for testing the virtual content they are authoring, or test their virtual content on a range of different scenes, etc.

### Example Methods

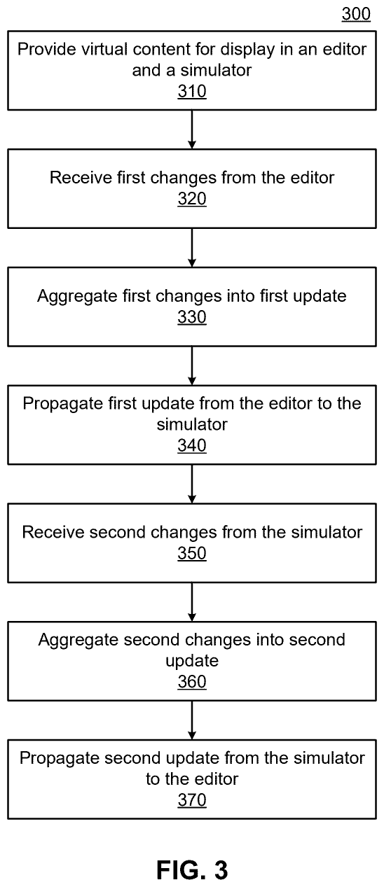

FIG. 3 illustrates a method 300 for two-way synchronization between an editor and a simulator, according to one embodiment. The steps of FIG. 3 are illustrated from the perspective of the development server 110 performing the method 300. However, some or all of the steps may be performed by other entities or components. In addition, some embodiments may perform the steps in parallel, perform the steps in different orders, or perform different steps.

In the embodiment shown, the method 300 begins with the development server 110 providing 310 an environment that includes virtual content in the editor and the simulator. The development server 110 receives 320, from the editor, first changes to the virtual content, such as edits to the properties of virtual objects or the addition/deletion of virtual objects. The first changes are aggregated 330 into a first update that is propagated 340 from the editor to the simulator. The development server 110 receives 350, from the simulator, second changes to the virtual content resulting from interaction with the virtual content according to the application logic, aggregates 360 the second changes into a second update, and propagates 370 the second update from the simulator to the editor. Thus, using the method 300, changes made to the virtual content in either the editor or the simulator automatically propagate from one to the other in either direction. This can enable developers to efficiently update and test their application without the need for expensive code compilation or switching between different tools.

### Computing System Architecture

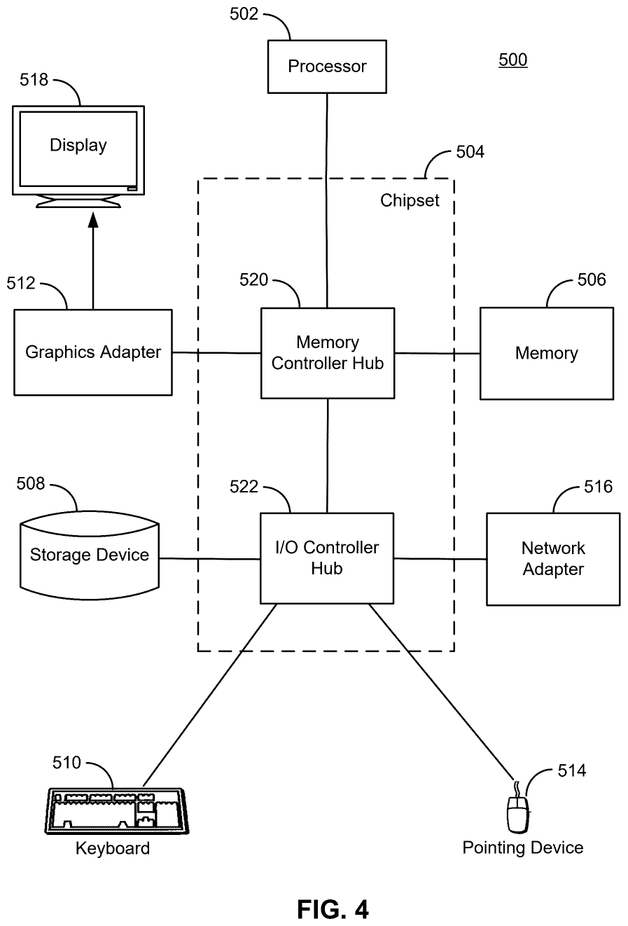

FIG. 4 is a block diagram of an example computer 400 suitable for use as a development server 110, developer client device 140, or end user client device 150. The example computer 400 includes at least one processor 402 coupled to a chipset 404. The chipset 404 includes a memory controller hub 420 and an input/output (I/O) controller hub 422. A memory 406 and a graphics adapter 412 are coupled to the memory controller hub 420, and a display 418 is coupled to the graphics adapter 412. A storage device 408, keyboard 410, pointing device 414, and network adapter 416 are coupled to the I/O controller hub 422. Other embodiments of the computer 400 have different architectures.

In the embodiment shown in FIG. 4, the storage device 408 is a non-transitory computer-readable storage medium such as a hard drive, compact disk read-only memory (CD-ROM), DVD, or a solid-state memory device. The memory 406 holds instructions and data used by the processor 402. The pointing device 414 is a mouse, track ball, touchscreen, or other type of pointing device, and may be used in combination with the keyboard 410 (which may be an on-screen keyboard) to input data into the computer system 400. The graphics adapter 412 displays images and other information on the display 418. The network adapter 416 couples the computer system 500 to one or more computer networks, such as network 170.

The types of computers used by the entities of FIGS. 1 and 2 can vary depending upon the embodiment and the processing power required by the entity. For example, the development server 110 might include multiple blade servers working together to provide the functionality described. Furthermore, the computers can lack some of the components described above, such as keyboards 410, graphics adapters 412, and displays 418.

### ADDITIONAL CONSIDERATIONS

Some portions of above description describe the embodiments in terms of algorithmic processes or operations. These algorithmic descriptions and representations are commonly used by those skilled in the computing arts to convey the substance of their work effectively to others skilled in the art. These operations, while described functionally, computationally, or logically, are understood to be implemented by computer programs comprising instructions for execution by a processor or equivalent electrical circuits, microcode, or the like. Furthermore, it has also proven convenient at times, to refer to these arrangements of functional operations as modules, without loss of generality.

Any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment. Similarly, use of “a” or “an” preceding an element or component is done merely for convenience. This description should be understood to mean that one or more of the elements or components are present unless it is obvious that it is meant otherwise.

Where values are described as “approximate” or “substantially” (or their derivatives), such values should be construed as accurate+/−10% unless another meaning is apparent from the context. For example, “approximately ten” should be understood to mean “in a range from nine to eleven.”

The terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Upon reading this disclosure, those of skill in the art will appreciate still additional alternative structural and functional designs. Thus, while particular embodiments and applications have been illustrated and described, it is to be understood that the described subject matter is not limited to the precise construction and components disclosed. The scope of protection should be limited only by the following claims.

What is claimed is:

1. A method comprising:
providing virtual content for display in an editor and a simulator, the virtual content being part of an application that includes application logic defining user interaction with the virtual content;
receiving, from the editor, one or more first changes to one or more properties of the virtual content;
aggregating the one or more first changes into a first update;
propagating the first update from the editor to the simulator;
receiving, from the simulator, one or more second changes to the virtual content resulting from interaction with the virtual content according to the application logic;
aggregating the one or more second changes into a second update; and
propagating the second update from the simulator to the editor.

2. The method of claim 1, wherein the first update is implemented using a conflict-free replicated data type (CRDT) library configured to maintain conflict-free synchronization of the virtual content between the editor and the simulator.

3. The method of claim 2, wherein changes of the one or more first changes having a first type are propagated from the editor to the simulator using the CRDT library and changes of the one or more first changes having a second type are propagated from the editor to the simulator separately from the CRDT library.

4. The method of claim 3, wherein the first type includes creation and deletion of virtual objects.

5. The method of claim 3, wherein the second type includes changes in position of virtual objects.

6. The method of claim 1, wherein aggregating the one or more first changes into the first update comprises:
maintaining a reference copy of a synchronized state of the virtual content;
maintaining a working copy of the virtual content associated with the one or more first changes;
identifying one or more differences by comparing the working copy to the reference copy; and
generating the first update based on one or more differences.

7. The method of claim 1, further comprising managing a session, wherein the session is configured to manage a synchronized state of the virtual content for multiple users.

8. The method of claim 1, further comprising:
accessing, from a datastore, stored sensor data generated by a client device; and
simulating interaction with the virtual content by the client device using the stored sensor data.

9. The method of claim 8, wherein the stored sensor data includes video data and motion data, the method further comprising converting the stored sensor data into a standard input format to simulate receiving live sensor data from the client device interacting with the virtual content.

10. The method of claim 9, wherein the sensor data further comprises timestamps synchronizing the video data and the motion data.

11. A non-transitory computer-readable medium comprising stored instructions that, when executed, cause a computing system to perform operations including:
providing virtual content for display in an editor and a simulator, the virtual content being part of an application that includes application logic defining user interaction with the virtual content;
receiving, from the editor, one or more first changes to one or more properties of the virtual content;
aggregating the one or more first changes into a first update;
propagating the first update from the editor to the simulator;
receiving, from the simulator, one or more second changes to the virtual content resulting from interaction with the virtual content according to the application logic;
aggregating the one or more second changes into a second update; and
propagating the second update from the simulator to the editor.

12. The non-transitory computer-readable medium of claim 11, wherein the first update is implemented using a conflict-free replicated data type (CRDT) library configured to maintain conflict-free synchronization of the virtual content between the editor and the simulator.

13. The non-transitory computer-readable medium of claim 12, wherein changes of the one or more first changes having a first type are propagated from the editor to the simulator using the CRDT library and changes of the one or more first changes having a second type are propagated from the editor to the simulator separately from the CRDT library.

14. The non-transitory computer-readable medium of claim 13, wherein the first type includes creation and deletion of virtual objects.

15. The non-transitory computer-readable medium of claim 13, wherein the second type includes changes in position of virtual objects.

16. The non-transitory computer-readable medium of claim 11, wherein aggregating the one or more first changes into the first update comprises:
maintaining a reference copy of a synchronized state of the virtual content;
maintaining a working copy of the virtual content associated with the one or more first changes;
identifying one or more differences by comparing the working copy to the reference copy; and
generating the first update based on one or more differences.

17. The non-transitory computer-readable medium of claim 11, wherein the operations further include managing a session, wherein the session is configured to manage a synchronized state of the virtual content for multiple users.

18. The non-transitory computer-readable medium of claim 11, wherein the operations further include:
accessing, from a datastore, stored sensor data generated by a client device; and
simulating interaction with the virtual content by the client device using the stored sensor data.

19. The non-transitory computer-readable medium of claim 18, wherein the stored sensor data includes video data and motion data, and the operations further include converting the stored sensor data into a standard input format to simulate receiving live sensor data from the client device interacting with the virtual content.

20. The non-transitory computer-readable medium of claim 19, wherein the sensor data further comprises timestamps synchronizing the video data and the motion data.
